(19) United States
(12) Patent Application Publication
(10) Pub. No.: US 2017/0106442 A1
(43) Pub. Date: Apr. 20, 2017

(54) SEGMENTED DISCHARGE TROUGH

(71) Applicant: Uwe GEIB, Uffing a. Staffelsee (DE)

(72) Inventor: Uwe GEIB, Uffing a. Staffelsee (DE)

(21) Appl. No.: 15/315,803

(22) PCT Filed: Jun. 3, 2015
(86) PCT No.: PCT/EP2015/062316

§ 371 Date: Dec. 2, 2016

(30) Foreign Application Priority Data
Jun. 3, 2014 (DE) 10 2014 107 778.4

(51) Int. Cl. B22D 37/00; B22D 41/16; C03B 7/02; B22D 39/00; C03B 7/088; C03B 5/26

(52) U.S. Cl. CPC B22D 37/00; C03B 7/088; C03B 5/26; C03B 7/02; B22D 39/00; B22D 41/16

(57) ABSTRACT

The invention relates to a pouring device (1) for supplying molten material (10) from a melting furnace (2) via an outlet (3) of the melting furnace (2) to at least one production unit (6), comprising a discharge trough (5) sub-divided into segments (4), wherein at least one segment (4) has a discharge (42) for the molten material (10), and wherein at least one segment (4) has at least one movable partition (44).

### TECHNICAL FIELD

The present invention relates to casting apparatuses for supplying melt, in particular glass melt, metal melt and mineral melt, out of a melt furnace to one or more production units.

### PRIOR ART

Outflow troughs for supplying melt out of a melt furnace are known in the prior art, for example from DE 199 35 664 A1. Furthermore, feeder heads are known which have an outflow for the melt and which are arranged exchangeably on the outflow troughs. Furthermore, outflow troughs or vessels are known which have automatically exchangeable casting pipes.

An outflow trough is to be understood to mean an apparatus which substantially constitutes a channel for the distribution of melt over a certain region. Said channel may have outlet openings and/or feeder heads which enable the melt that is introduced into the outflow trough to be supplied into downstream production units.

Owing to abrasion, wear and/or corrosion, it is necessary for not only the casting pipes of the outflows, but likewise at regular intervals the feeder heads, and at greater intervals the outflow troughs, to be exchanged. In the present prior art, apparatuses are known which permit the exchange of the casting pipes, which are subject to intense abrasion, during production. For an exchange of a feeder head or of parts of or of the entire outflow trough, the supply of the melt must be interrupted, which leads to a stoppage of the production process.

### PRESENTATION OF THE INVENTION

Taking the known prior art as a starting point, it is an object of the present invention to provide an improved casting apparatus and a method in order, in particular, to improve the distribution of melt, in particular of glass melt, metal melt and mineral melt, in a continuous casting process.

In this document, the casting apparatus is to be understood to mean an apparatus which has an outflow trough and means for moving, handling and/or changing the outflow trough or any components of the outflow trough.

Said object is achieved by way of a casting apparatus having the features of claim 1 and by way of a method having the features of claim 8. Advantageous refinements emerge from the sub claims.

Correspondingly, a casting apparatus for supplying melt from a melting furnace to at least one production unit is specified. Here, an outflow trough which is divided into segments is provided, wherein at least one segment has an outflow for the melt and at least one segment has at least one movable partition.

The outflow trough has a main direction of extent and has two ends and thus has a longitudinal axis which extends in the main direction of extent, and said outflow trough is in this case divided, perpendicularly to its main direction of extent or its longitudinal axis, into segments.

The segments may in this case be composed of multiple layers. Accordingly, at the inside, there is arranged a material which is substantially resistant to the melt to be processed. Toward the outside, there may be provided various layers for insulation, and elements for heating and cooling, for example lines, in particular bores or drilled ducts in the insulation, for air and/or a fluid, and layers for stabilizing the outflow trough. Through the outflow of the at least one segment, melt can pass to at least one production unit situated below the outflow trough. The conducting of the air or of the fluid for heating or cooling purposes may in this case be performed both cyclically and continuously. It is alternatively also possible for air or fluid for heating and air or fluid for cooling to be conducted alternately in accordance with requirements.

By way of movable partitions in individual segments, the flow of the melt to the outflows can be controlled. In particular, closed partitions at the ends of the outflow trough prevent the melt from being able to flow off out of the outflow trough.

In a refinement of the casting apparatus, at least one of the segments of the outflow trough is exchangeable.

As a result of the division of the outflow trough into segments, it is possible for individual segments to be added, to be removed, to be exchanged and/or to be processed. The segments are preferably fastened to one another by way of a positively locking action, particularly preferably by way of a tongue-and-groove connection.

In a preferred refinement of the casting apparatus, the at least one partition of the at least one segment which has the partition has an opened position, in which the flow of the melt through the at least one segment which has the partition is permitted. Furthermore, the at least one partition has a closed position, in which the flow of the melt downstream of the movable partition is prevented.

In this way, individual segments or regions of the outflow trough can be incorporated into or separated from a flow region of the melt. The flow region of the melt extends in this case from at least one supply of the melt to the two ends of the outflow trough as viewed in the direction of the longitudinal axis of the outflow trough, wherein the flow region is delimited in the longitudinal direction by the at least one partition if the latter is in the closed position. Segments situated downstream of the closed partition with respect to the flow region thus do not come into contact with the flow region of the melt.

Said segments situated downstream of the closed partition can be exchanged or processed without the supply of the melt from the melt furnace into the outflow trough having to be interrupted. Thus, continuous operation is possible, and the supply of the melt to the at least one production unit can be performed in parallel with processing, removal or exchange of the segments situated downstream, and/or with an addition of at least one new segment at one end of the outflow trough.

The melting furnace may have at least one outlet for the continuous supply of the melt into the outflow trough.

Alternatively, the supply of the melt from the melting furnace into the outflow trough may also be performed cyclically, in particular by way of vessels, preferably by way of casting ladles. This embodiment may be used for example if the casting apparatus is provided for a process engineering step, for example for the pigmentation of the melt.

In a preferred embodiment of the casting apparatus, the partition of the at least one segment which has the partition is arranged upstream of an outflow of the same segment. By way of this arrangement, the at least one outflow can be separated from the flow region of the melt.

Alternatively, the partition may also be arranged downstream of an outflow of the same segment. In this way, it is possible for the flow region of the melt to be separated from a segment arranged downstream of the segment which has the partition. Furthermore, by way of this arrangement of the partition, an outflow of the segment which has the partition can be situated within the flow region of the melt and provided for conducting melt to a production unit arranged below the outflow.

In a further preferred embodiment, the at least one segment has in each case one partition both upstream and downstream of an outflow of the segment. Here, the partitions may be movable independently of one another. Alternatively, the partitions may also be coupled in terms of their movement.

The at least one partition is preferably arranged perpendicular to the longitudinal axis of the outflow trough. In this way, the arrangement of the at least one partition on the at least one segment can be performed with minimal outlay in terms of material and manufacturing. It is perfectly possible for the at least one partition to be displaced between the opened position and the closed position by way of a stroke movement. The stroke movement may in this case be performed mechanically, electrically or manually, for example.

Alternatively, the partition may also be provided so as to be rotatable. The rotatable partition then preferably has an opened position, in which the partition is arranged parallel to the longitudinal axis of the outflow trough, and a closed position, in which the partition is arranged perpendicular to the longitudinal axis of the outflow trough and sealingly closes off the corresponding segment which has the partition.

In a further preferred embodiment, the at least one segment which has at least one outflow has at least one closure means for opening or closing the at least one outflow. Here, the at least one closure means is arranged above and concentrically with respect to the at least one outflow, and is movable perpendicularly to the at least one outflow. The at least one closure means preferably has an opened position and a closed position and is preferably displaceable between the two positions by way of a stroke movement, wherein the at least one closure means, in the closed position, sealingly closes off the at least one outflow and, in the opened position, has no influence on the flow conditions of the melt at the at least one outflow.

In a preferred embodiment, a volume flow of the melt flowing through the at least one outflow can be regulated by way of the position of the at least one closure means. The position of the at least one closure means is in this case preferably adjustable in continuously variable fashion from the opened position to the closed position.

Alternatively, the volume flow of the melt flowing through the gap may be adjustable by way of the position of the at least one partition and thus the size of a gap provided by the at least one partition and the base of the at least one segment which has the at least one partition.

In a preferred refinement, the outflow trough is arranged so as to be displaceable along its longitudinal axis. The magnitude of the displacement preferably corresponds to the length of the at least one segment, such that, after the displacement, a second segment is situated in the position that was occupied by a first segment before the displacement. In this way, it is also the case that the at least one outflow of the second segment is situated in the position that was occupied by the at least one outflow of the first segment before the displacement. It can thus be ensured that the supply of the melt to the at least one production unit takes place at substantially the same position before and after the displacement.

By virtue of the fact that the outflow trough is arranged so as to be displaceable along its longitudinal axis, it is possible for individual segments to be added or removed at the ends of the apparatus without interrupting the flow of the melt from the supply into the outflow trough, as will be discussed below.

In a preferred refinement, the at least one segment may be of U-shaped form. In other words, the at least one segment has a flat or curved base and has two side walls and two open ends through which melt can flow in and out. The at least one outflow is in this case provided on the base of the at least one segment. Here, at the open ends, segments may be connected to one another preferably by way of a positively locking action.

Alternatively, the at least one segment may, at least in the region of the at least one outflow, have a funnel in the base, at the lower, narrow end of which funnel the outflow is provided concentrically with respect to the funnel. By way of the funnel, it is firstly possible for the supply of the melt to the at least one outflow to be improved, and secondly, owing to a higher level above the at least one outflow in relation to the base without a funnel, a higher partial pressure is generated at the at least one outflow, wherein, with increasing partial pressure, an outflow speed of the melt also increases. Thus, the outflow speed of the melt at the at least one outflow can be influenced by way of the geometry of the segments.

In a preferred embodiment, a guide for the transfer of the melt may be at least intermittently provided between the at least one outlet of the melting furnace and the outflow trough. By way of the guide, it is ensured that the melt flows from the at least one outlet into the outflow trough. In particular if the segments of the outflow trough have a width which varies along the longitudinal direction of the outflow trough, for example in the case of segments which have circular funnel regions and connecting regions which are narrower than the diameter of the funnel at its thickest point, it would be possible, during a movement of the outflow trough along its longitudinal direction, for melt to flow past the narrow connecting regions at the outside if the at least one outlet is oriented toward the funnel regions. Through the provision of the guide, the melt can be diverted such that it also flows into the narrow connecting regions.

At least one of the segments of the outflow trough may, in a preferred refinement, have at least one barrier for delimiting the flow region of the melt, wherein the at least one barrier provides at least one passage through which the melt can flow. In one refinement, the passage is arranged in the region of the segment close to the base. If the segment is filled with melt on one side of the barrier, the at least one passage in the vicinity of the base has the effect that only melt in the vicinity of the base passes the barrier. In this way, inhomogeneities or solidified regions of the melt, which are encountered substantially in the region of the melt close to the surface, can be prevented from passing into the region on the other side of the barrier. Alternatively, the at least one passage may also be provided at some other region of the at least one barrier.

In a refinement, at least one segment may also have multiple barriers, wherein the passages of the barriers may be arranged at different regions of the barriers in order to further intensify the above-described positive effect.

It is preferably possible for at least one partition to be provided upstream of the at least one barrier. The at least one partition may be held in the closed position until a predetermined level of the melt has been set. If, after the level has been reached, the partition is opened, the level of the melt is present at the at least one barrier, such that it is possible to prevent disruptive elements in the melt from passing through the at least one passage of the at least one barrier.

The segments, partitions and/or barriers may for example be manufactured from coarse ceramic, from a metal or from a metal alloy, such as for example a platinum-rhodium alloy, or from other suitable materials.

Heating and/or cooling elements, in particular bores and drilled ducts, through which air and/or a fluid can be conducted may be arranged in or on the segments and/or within the barrier, the partition and/or the closure means in order to make it possible to regulate the temperature of the melt.

In one embodiment, components of the outflow trough such as the barriers and/or the partitions and/or the closure means may be exchangeable. It is thus possible for said components to be individually or severally exchanged when they are situated in their opened position, without influencing the production process.

The invention likewise relates to a method for exchanging a segment of an outflow trough which is composed of multiple segments as described above. Here, at least one segment has an outflow and at least one segment has a partition. According to the invention, the partition is firstly closed in order that the segment to be exchanged is separated from the other segments of the outflow trough. Melt still remaining in the segment to be exchanged may be evacuated if necessary. Subsequently, the segment to be exchanged is separated from the other segments and is removed from the outflow trough. Finally, a new segment is added to the outflow trough and is connected to the other segments. By virtue of the previously closed partition, or possibly another partition, being opened, the added segment is also fluidically connected to the other segments.

In a preferred embodiment of the method, the removal of the segment to be exchanged and the addition of the new segment are performed at one end of the outflow trough.

In a further preferred embodiment of the method, the removal of the segment to be exchanged is performed at one end of the outflow trough, and the addition of the new segment is performed at another end of the outflow trough.

It is alternatively also possible for an “inner” segment of the outflow trough, which is connected at both sides to other segments, to be removed. The segment to be added may then be added either at the same location, or the remaining segments are connected to one another and the segment to be added is added at one end of the outflow trough.

In a preferred embodiment, only some segments have at least one partition, one barrier and/or one outflow with or without a closure means and are connected by way of at least one segment without a partition or outflow or barrier, which at least one segment is thus utilized as a connecting element. For example, one segment may have an outflow, and two adjacent segments may have in each case one partition. Other configurations of the outflow trough by way of other possible combinations of differently designed segments are also possible.

For the purposes of improved insulation, the outflow trough may at least in one region have a cover, for example a lid or a closure means, at least on a top side. Here, the top-side cover may be provided so as to be static, or else may be arranged as a top-side cover which moves together with the outflow trough, wherein the top-side cover may have openings for the supply of the melt into the outflow trough. Here, the openings may likewise be provided so as to be closable. The top-side cover may be of unipartite or segmented form, and may for example be composed of one or more layers, correspondingly to the construction of the segments.

### BRIEF DESCRIPTION OF THE FIGURES

Preferred further embodiments and aspects of the present invention will be discussed in more detail by way of the following description of the figures, in which:

FIG. 1a schematically shows a side view in cross section through a segment of an outflow trough with a partition in an opened position and a closure means in an opened position;

FIG. 1b schematically shows the segment from FIG. 1a with throughflowing melt;

FIG. 1c schematically shows a plan view of the segment from FIG. 1a;

FIG. 2a schematically shows a side view in cross section through a segment of an outflow trough with a partition in a closed position and a closure means in a closed position;

FIG. 2b schematically shows the segment from FIG. 2a with throughflowing melt;

FIG. 2c schematically shows a side view in cross section through a segment of an outflow trough with a partition in a closed position and a closure means in an opened position;

FIG. 2d schematically shows the segment from FIG. 2c with throughflowing melt;

FIG. 3 schematically shows a side view in cross section through a casting apparatus;

FIG. 4 schematically shows a plan view of a casting apparatus;

FIG. 5 schematically shows a front view in cross section through the casting apparatus from FIG. 4;

FIG. 6 schematically shows a plan view of a casting apparatus with segments in an alternative embodiment;

FIG. 7 schematically shows a front view in cross section through a casting apparatus with a provided guide;

FIG. 8 schematically shows a plan view of a casting apparatus with two outflows per segment;

FIG. 9 schematically shows a plan view of a segment of a casting apparatus with a partition at both ends of the segment;

FIG. 10 schematically shows a plan view of a segment of a casting apparatus with two partitions at one end of the segment;

FIG. 11a schematically shows a plan view of a segment of a casting apparatus with one partition and two barriers at one end of the segment;

FIG. 11b schematically shows a side view in cross section through the segment from FIG. 11a;

FIG. 12 schematically shows a side view in cross section through a segment of an outflow trough with a rotatable partition in an opened position; and

FIG. 13 schematically shows a side view in cross section through a segment of an outflow trough with a rotatable partition in a closed position.

### DETAILED DESCRIPTION OF PREFERRED EXEMPLARY EMBODIMENTS

Below, preferred exemplary embodiments will be described on the basis of the figures. Here, identical or similar elements or elements of identical action are denoted by identical reference designations. To avoid redundancies, a repeated description of said elements will, in part, be omitted in the following description.

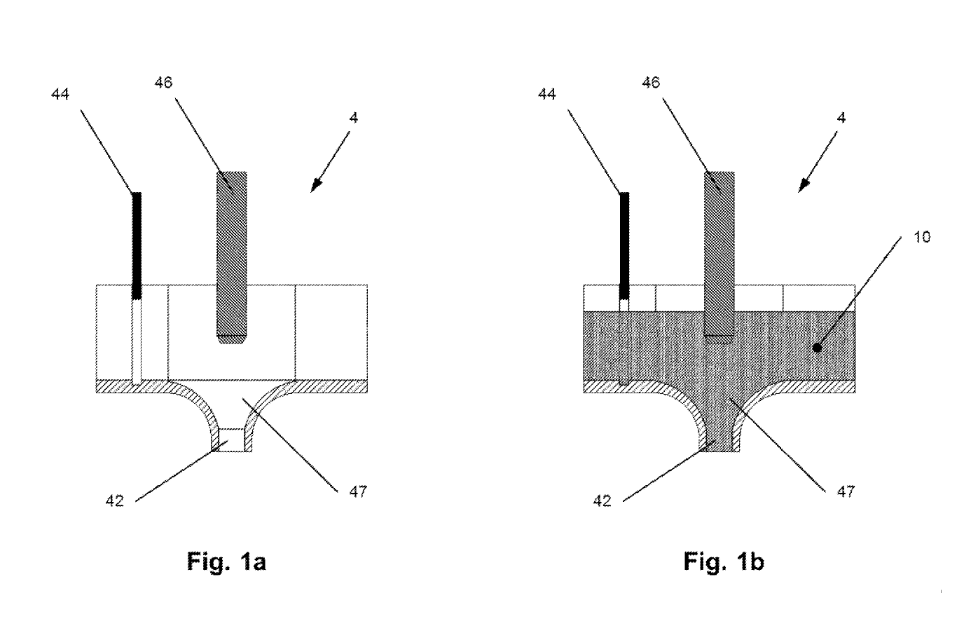

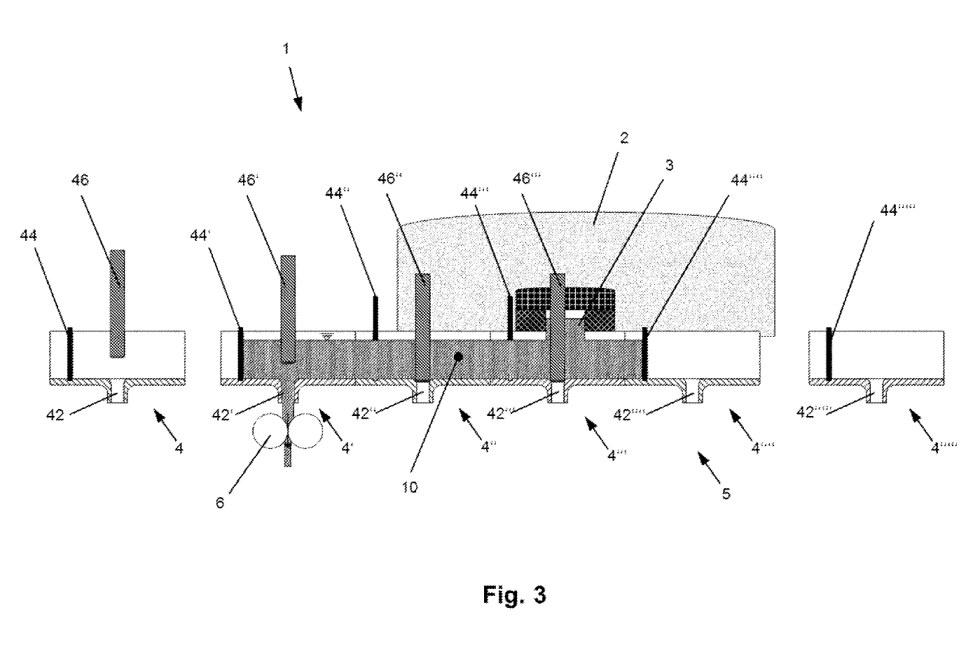

The illustration of FIG. 1 a schematically shows a side view in cross section through a segment 4 of an outflow trough for a casting apparatus for supplying melt from a melting furnace, via an outlet of the melting furnace, to at least one production unit. The segment 4 has, at its bottom side, an outflow 42 and a funnel 47 which generates an increased level in relation to a segment base of flat form (as shown for example in FIG. 5) and thereby increases the magnitude of a partial pressure in the melt 10 prevailing at the outflow 42, whereby an outlet speed of the melt 10 is increased. Melt which flows through the segment 4 can flow out through the outflow 42. Provided above the outflow is a closure means 46 in an opened position, which closure means is arranged so as to be displaceable concentrically with respect to an outflow axis of the outflow. Furthermore, the segment 4 has a partition 44 in an opened position.

If melt (not shown here) flows along the segment 4 from right to left, a part of the melt flows through the outflow 42 to a production unit (not shown here). A further part of the melt flows along the segment 4 and passes the opened partition 44.

FIG. 1b shows the segment 4 from FIG. 1a with throughflowing melt 10.

FIG. 1c shows the segment from FIG. 1a schematically in a plan view. The partition 44 runs over the entire width of the segment 4 and is mounted in displaceable fashion at its two side walls. The closure means 46 (not shown here) is of cylindrical form and is situated above the outflow 42, which likewise has a circular cross section. Alternatively, the outflow 42 and the closure means 46 may also have some other geometry, for example a rectangular cross section.

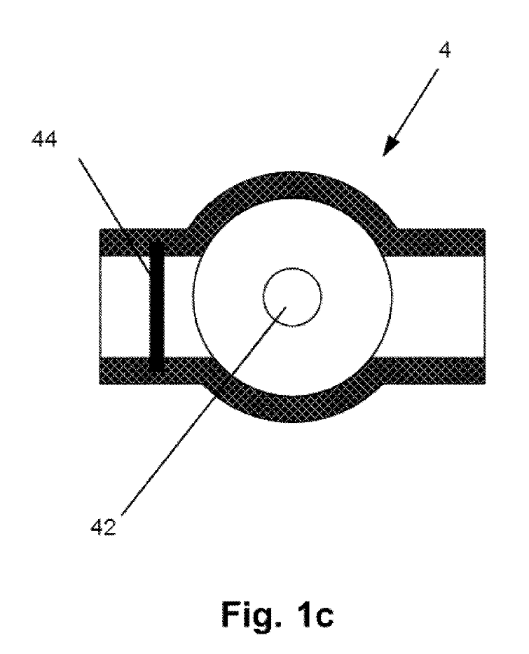

FIG. 2a schematically shows the segment 4 from FIG. 1a and 1b with the partition 44 in a closed position and the closure means 46 in a closed position. In relation to the opened position of the partition as per FIG. 1a, the partition 44 has in this case been displaced vertically in the direction of the bottom side of the segment 4, and thereby sealingly closes off the passage of the segment 4 both at the side surfaces and at the base of the segment 4. Melt which flows along the segment 4 strikes the closed partition 4, which prevents an onward flow of the melt. Furthermore, the closure means 46 is shown in a closed position in which it, by way of its lower end, seals off the outflow 42, such that no melt can flow through the outflow 42. Since the closure means 46 occupies only a part of the width of the segment 4, melt can flow along the segment 4 past the closure means 46.

FIG. 2b shows the segment 4 from FIG. 2a with melt 10 which flows into the segment from the right.

The partition 44 and the closure means 46 may assume the positions shown in FIGS. 1a and 2a in a coupled manner or independently of one another. Their movement may be realized for example mechanically, pneumatically, electrically or manually.

FIGS. 2c and 2d show the segment 4 from FIGS. 1 a to 2b, wherein the partition 44 is situated in the closed position and the closure means 46 is situated in the opened position.

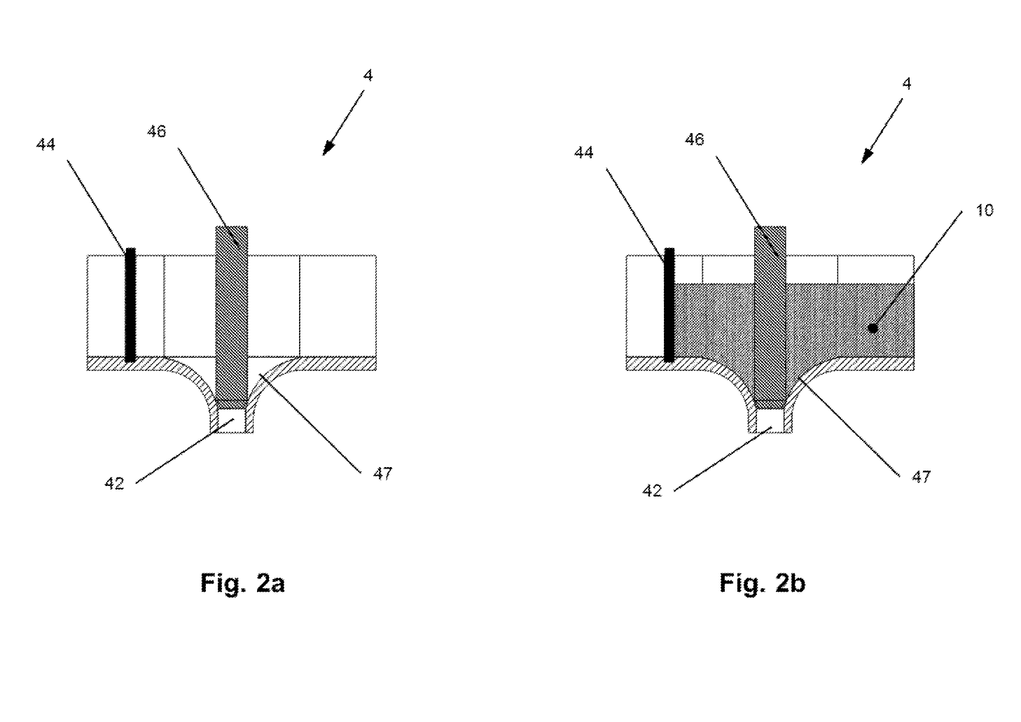

FIG. 3 schematically shows a side view in cross section through a casting apparatus 1. An outflow trough 4 is formed by four lined-up segments 4′, 4″, 4′″, 4″″ as per FIGS. 1a to 2d. The outflow trough 5 is connected by way of an outlet 3 to a melting furnace 2. A melt 10 flows out of said melting furnace via the outlet 3 into the outflow trough 5. The outflow trough 5 is delimited by the closed partitions 44′ and 44″″. The opened partitions 44″, 44′″ allow the melt 10 to flow through the outflow trough 5 as far as the closed partitions 44′, 44″″. A production unit 6 for the further processing of the melt 10 is arranged below the segment 4′. Owing to the fact that the closure means 46″ and 46′″ are in the closed position, the outflows 42″ and 42′″ are closed, such that no melt 10 can flow through. Since the closure means 46′ is in the opened position, the melt can emerge through the outflow 42′ and pass to the production unit 6 situated therebelow, where further processing of the melt 10 is performed.

Since the closed partitions 44′, 44″″ delimit the flow region of the melt 10 to the outside, a change of the outflow trough 5 in the regions outside the closed partitions 44′, 44″″ is made possible. It is thus possible for individual or several segments 4, 4′″″ to be added, removed, exchanged and/or processed. This is schematically indicated by way of the loose segments 4, 4′″″ which are spaced apart from the outflow trough 5. The addition, removal, exchange and/or processing of the segments 4, 4′″″ is possible here without completely evacuating the outflow trough, such that the abovementioned handling operations can be performed without interrupting the manufacturing process.

Owing to the closure means 46, 46′, 46″, 46′″ which are closable independently of one another, the periphery of the casting apparatus can be individually adapted to the respective demands of the manufacturing process. The outflows 42″″, 42′″″ of the segments 4″″, 4′″″ without a closure means can in this case be incorporated into the melt flow merely by way of a raising or lowering, or opening or closing, of the partitions 44″″, 44′″″. Furthermore, the closure means 46, 46′, 46″, 46′″ may be kept closed until the melt 10 in the outflow trough 5 has reached a certain level, whereby, upon opening of one or more closure means 46, 46′, 46″, 46′″, defined flow conditions of the melt 10 can be provided in the respective outflow(s).

By way of the position of the closure means 46, 46′, 46″, 46′″, the volume flow of the melt 10 flowing through the outflow 42, 42′, 42″, 42′″ can, by movement of the closure means 46, 46′, 46″, 46′″, be regulated from a maximum volume flow, when the closure means 46, 46′, 46″, 46′″ is in the opened position, to zero, when the closure means 46, 46′, 46″, 46′″ is fully closed. Accordingly, the volume flow of the melt 10 can be adjusted independently for each outflow 42, 42′, 42″, 42′″ in a manner dependent on the requirements of the manufacturing process and of the connected production units.

Both the closure means 46, 46′, 46″, 46′″ and the partitions 44, 44′, 44″, 44′″, 44″″, 44′″″ of the segments 4, 4′, 4″, 4′″, 4″″, 4′″″ are provided so as to be exchangeable, such that these can be exchanged for example owing to abrasion or wear, preferably by way of an exchanging unit which is not shown here. Alternatively, the exchange may also be performed manually.

The segments 4, 4′, 4″, 4′″, 4″″, 4′″″ are provided such that, after the closure of a partition 44, 44′, 44″, 44′″, 44″″, 44′″″ in a segment 4, 4′, 4″, 4′″, 4″″, 4′″″ upstream of the segment 4, 4′, 4″, 4′″, 4″″, 4′″″ to be exchanged, and after the drainage of the melt 10 from the segment 4, 4′, 4″, 4′″, 4″″, 4′″″ to be exchanged, an addition, removal or exchange is performed by way of a robot (not shown here). Alternatively, use may also be made of an apparatus, or the addition, removal or exchange may be performed manually.

In the casting apparatus 1 shown in FIG. 3, the outflow trough is arranged so as to be displaceable along its longitudinal axis. After a certain time interval, the closure means 46′, 46″, 46′″ of the segments 4′, 4″, 4′″, 4″″ presently arranged in the outflow trough 5 are closed. Subsequently, the segment 4 is connected to the outflow trough 5. Now, the outflow trough 5 can be displaced by the length of one segment 4, such that the outflow 42 of the new segment 4 of the outflow trough 5 is situated in the position of the outflow 42′ before the displacement of the outflow trough 5. After opening of the partition 46′, the flow region of the melt 10 extends as far as the closed partition 44 of the new segment 4.

Analogously, after the displacement of the outflow trough 5, the partition 44′″ can be closed in order to decouple the flow region of the melt from the segment 4″″. After evacuation of the segment 4′″, which is still filled with melt, through the outflow 42′″, the segment 4″″ can be removed from the outflow trough 5. Alternatively, the displacement of the partition 44′″ and the evacuation of the segment 4″″ may be performed before the movement of the outflow trough 5.

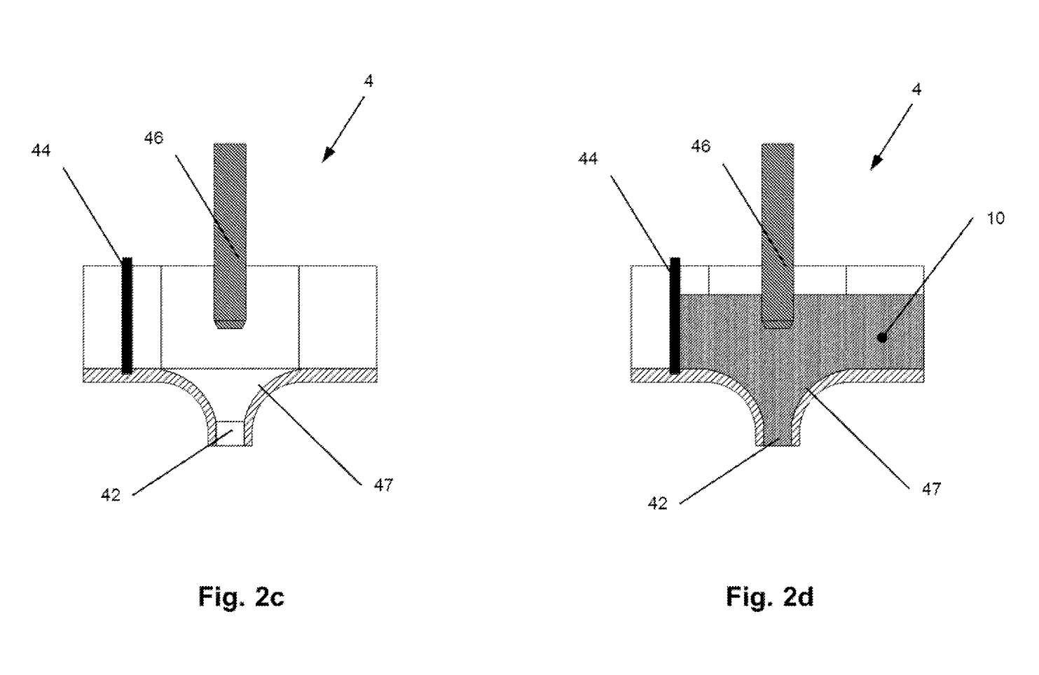

FIG. 4 schematically shows a plan view of a casting apparatus 1 of similar construction to that from FIG. 3. Analogously to the latter, in FIG. 4, an outflow trough 5 is supplied with a melt 10 by way of a melting furnace 2 and an outlet 3 of the melting furnace 2. The outflow trough 5 is in this case formed from three segments 4, 4′, 4″. The flow region of the melt 10 is defined by the closed partitions 44, 44″. The opened partition 44′ permits a flow of the melt 10 into the segment 4 of the outflow trough 5, such that the outflows, which are in this case hidden by the melt, of the segments 4, 4′ can be supplied with melt and conduct the latter to production units (not shown here). The outflow, hidden by the closure means 46″, of the right-hand segment 4″ is not charged with melt because it is, in relation to the flow region of the melt in the outflow trough 5, situated outside the closed partition 46″ that delimits the flow region.

FIG. 5 shows a cross section through the casting apparatus from FIG. 4 along the inflow of the melt 10 through the outlet 3 of the melting furnace 2. It can be seen that the melt 10 does not completely fill the segment 4′, such that the upper region of the closed partition 44″ can be seen above the melt level. The closure means 46′ is arranged in the closed position, in which it closes off the outflow 42′ of the segment 4′.

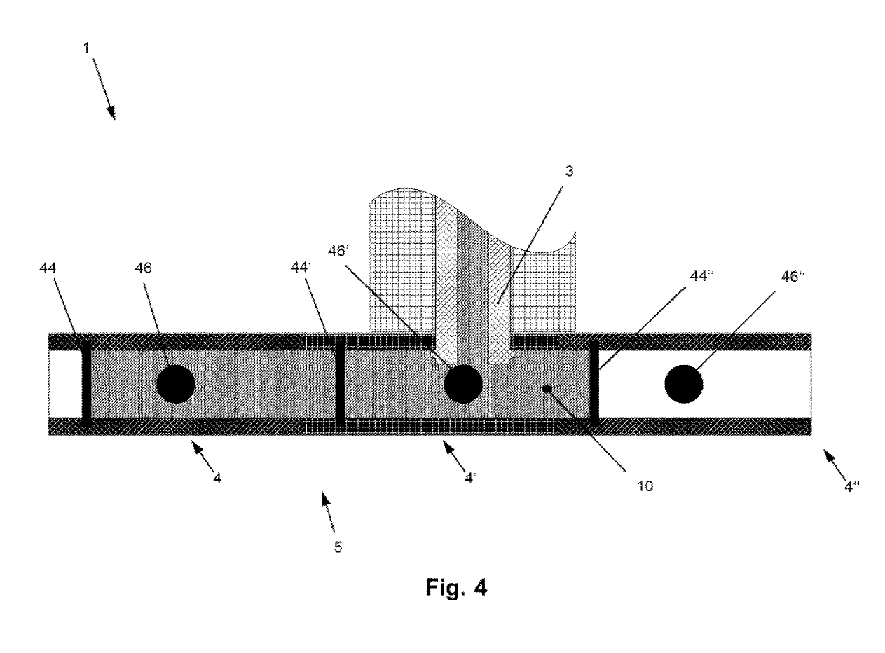

FIG. 6 schematically shows a partial region of a casting apparatus 1 whose segments 4, 4′, 4″ have, in the region of their outflows 42, 42′, 42″, a funnel 47, 47′, 47″ which generates an increased level in relation to a segment base of flat form (as can be seen for example in FIG. 5) and thereby increases the magnitude of a partial pressure in the melt 10 prevailing at the outflow 42, whereby an outlet speed of the melt 10 is increased. The flow region of the melt 10 in the outflow trough 5 is delimited on the right-hand side by the closed partition 44″. The opened partition 44′ permits a flow of the melt 10 from the outlet 3 of the melting furnace through the segment 4′ into the segment 4. Since the closure means 46, 46′ are in the opened position, the melt 10 is conducted through the outflows, which are hidden by the closure means 46, 46′, to the production units (not shown here) situated therebelow.

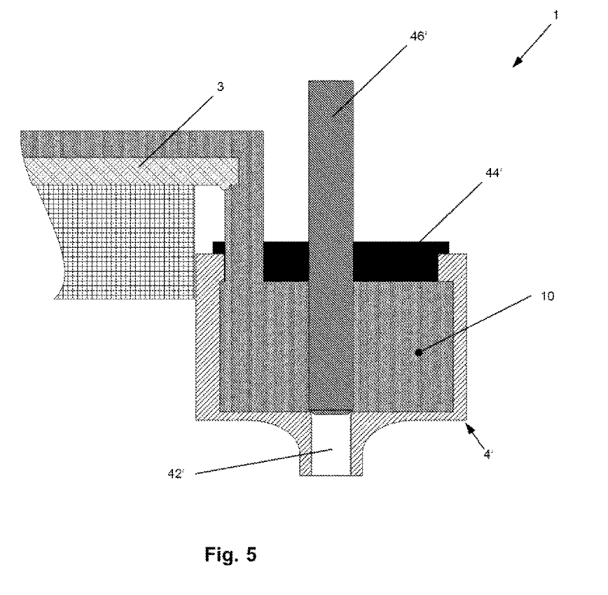

FIG. 7 shows a cross section through a casting apparatus corresponding to FIG. 6 along the inflow of the melt 10 through the outlet 3 of the melting furnace 2, wherein the sectioned segment 4 does not have a funnel. In the embodiment illustrated here, a guide for the transfer of the melt 10 is provided between the outlet 3 of the melting furnace and the outflow trough 5. By way of the guide, it is ensured that the melt flows from the outlet into the outflow trough even when the segments with funnel-shaped outlets have been displaced in the longitudinal direction, and thus the outlet 3 is situated above the relatively narrow connecting regions of the segments 4, 4′, 4″.

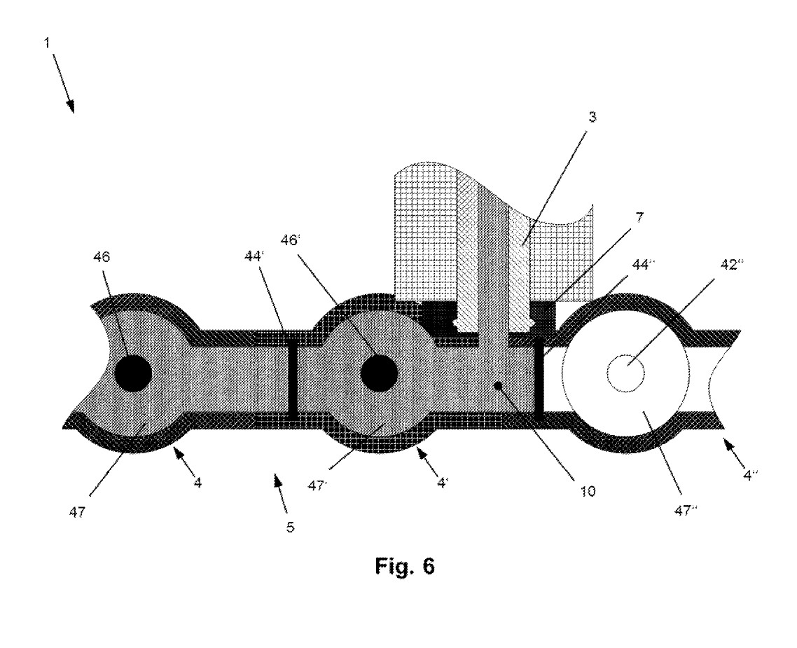

The casting apparatus 1 schematically shown in FIG. 8 corresponds to the casting apparatuses as per FIGS. 3 and 4, wherein the outflow trough 5 is composed of three segments 4, 4′, 4″ which are each equipped with two outflows 42″. These are arranged offset with respect to the central axis of the segments 4, 4′, 4″, such that the melt 10 can be supplied, below the outflow trough 5, to production units (not shown here) which are arranged offset. The left-hand and central segments 4, 4′ likewise have a closure means 46, 46′ for each outflow. Since the partition 44′ is in the opened position, the flow region of the melt 10 is delimited by the two closed partitions 44, 44″. The outflows 42″ of the segment 4″ are thus situated outside the flow region of the melt 10. Furthermore, the four closure means 46, 46′ are in an opened position above the outflows 42, 42′.

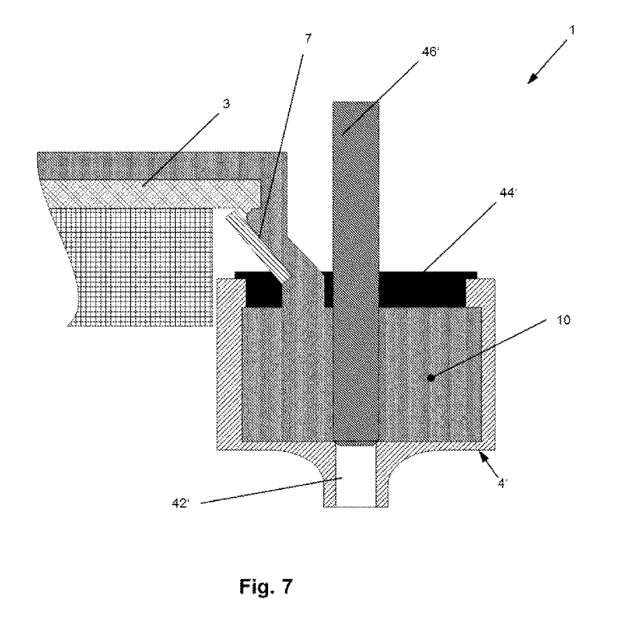

FIG. 9 schematically shows a segment 4 with a funnel 47 in the region of the outflow 42 and has, on both open sides, a movable partition 44, 44′, whereby the segment 4, regardless of its installation position in the outflow trough 5, permits an activation or blocking of the outflow 42 in the event of that partition 44 which is situated closer to the outlet 3 of the melting furnace 2 being lifted into the opened position, and/or as a result of lowering into the closed position. Furthermore, the volume flow of the melt flowing through the gap can be adjusted by way of the position of the partition 44 and thus the size of a gap provided by the partition and the base of the segment 4. In this way, it is possible to dispense with the closure means for the direct closure of the outflow 42 and/or for the adjustment of the volume flow at the outlet 42. Owing to the partition 44′ downstream of the outflow 42, the outflow 42 can be utilized even in the case of a position of the segment 4 in the outflow trough as per the segment 4″ from FIG. 5.

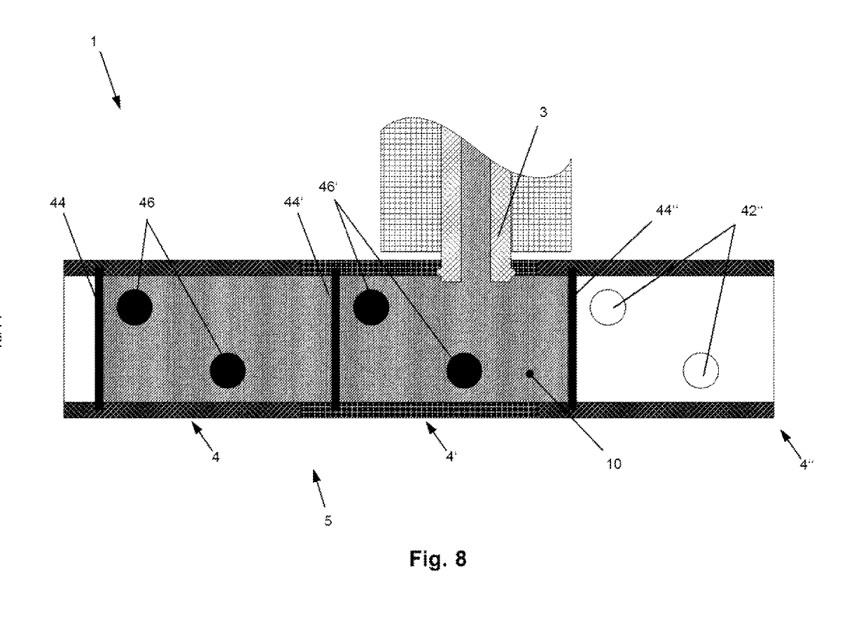

FIG. 10 shows a segment 4 with two partitions 44, 44′ on one side of the outflow 42. In the case of porous materials such as for example coarse ceramic, unsealed points may arise at the receptacle of the partition 44 in the segment 4. Through the provision of two partitions 44, 44′, increased reliability with regard to the sealing action is realized.

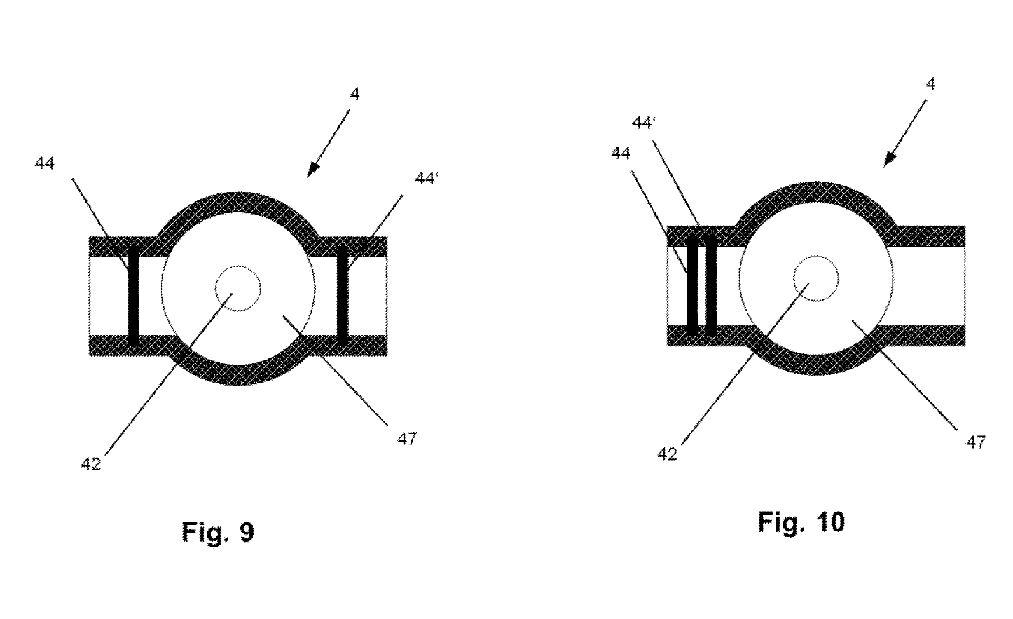

FIG. 11a and FIG. 11b show a segment 4 of a casting apparatus which, at one end, as viewed from the inside to the outside, has a partition 44, a first barrier 48 with a passage 482 in the lower region and a second barrier 48′ with a passage 482′ in the upper region. During filling of the segment 4, which is integrated into an outflow trough (not shown here), and after a certain level of the melt (not shown here) is reached, the partition 44 is opened. As a result, melt situated close to the base flows through the passage 482 in the lower region of the barrier 48, strikes the barrier 48′ and, after reaching the passage in the upper region 482′, flows into a further segment (not shown here) of the outflow trough.

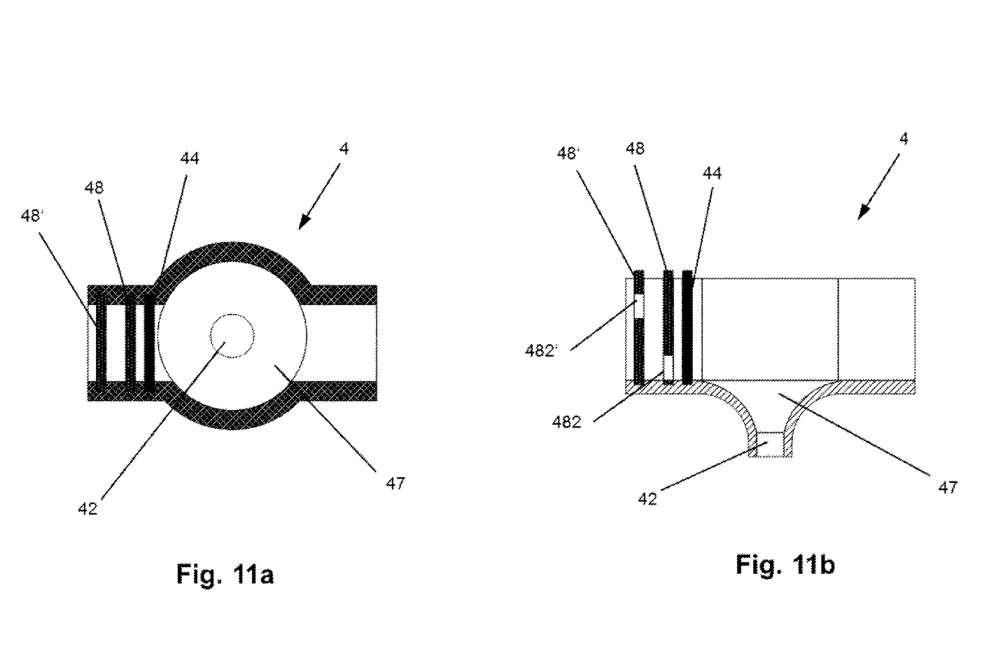

FIG. 12 shows a segment 4 in an alternative embodiment. Here, the partition 44 is rotatably mounted by way of a rotary joint 49. Since the partition 44 is in the closed position, the melt 10 cannot flow through the segment 4 and pass to the outflow situated under the closure means 46.

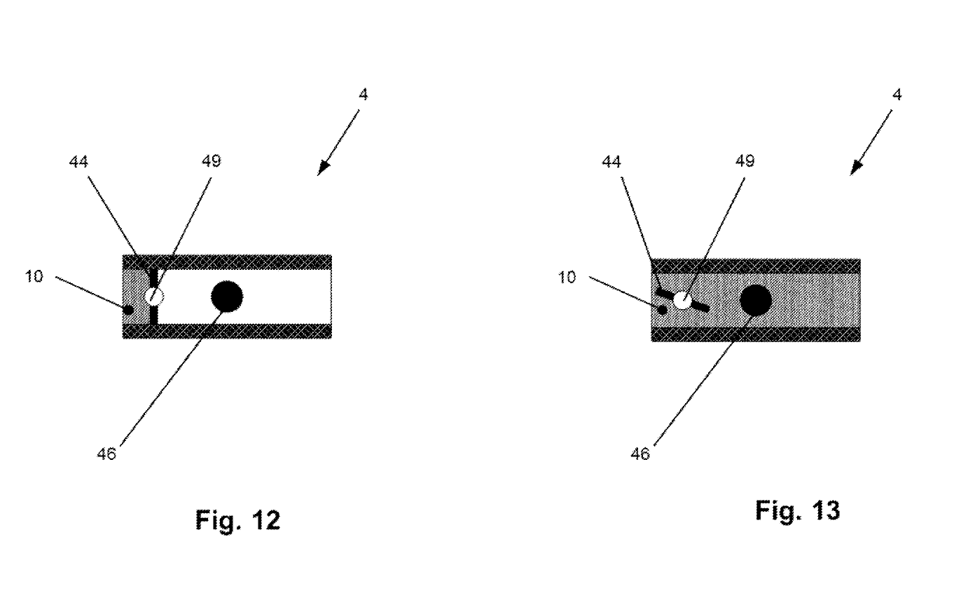

FIG. 13 shows the segment 4 from FIG. 12, wherein the partition 44 is in an opened position. In this way, the melt 10 can flow past the partition 44 and through the segment 4.

### LIST OF REFERENCE DESIGNATIONS

1 Casting apparatus
2 Melting furnace
3 Outlet
4 Segment
42 Outlet
44 Partition
46 Closure means
47 Funnel
48 Barrier
482 Opening
49 Rotary joint
5 Outflow trough
6 Production unit
7 Guide

1. A casting apparatus (1) for supplying melt (10) from a melting furnace (2) to at least one production unit (6), comprising an outflow trough (5) which is divided into segments (4), wherein at least one segment (4) has an outflow (42) for the melt (10), wherein at least one segment (4) has at least one movable partition (44).

2. The casting apparatus (1) as claimed in claim 1, wherein at least one segment (4) is exchangeable.

3. The casting apparatus (1) as claimed in claim 1, wherein the movable partition (44) has an opened position, in which the flow of the melt (10) through the at least one segment (4) which has the partition (44) is permitted, and a closed position, in which the flow of the melt (10) downstream of the movable partition (44) is prevented.

4. The casting apparatus (1) as claimed in claim 1, wherein the at least one segment (4) which has at least one outflow (42) has at least one closure means (46) for opening or closing the at least one outflow (42).

5. The casting apparatus (1) as claimed in claim 1, characterized in that the outflow trough (5) is arranged so as to be movable along its longitudinal axis.

6. The casting apparatus (1) as claimed in claim 1, wherein the melting furnace (2) has an outlet (3) for the supply of the melt (10) into the outflow trough (5), wherein a guide (7) for the transfer of the melt (10) is at least intermittently provided between the outlet (3) of the melting furnace (2) and the outflow trough (5). (Currently Amended) The casting apparatus (1) as claimed in claim 1, wherein at least one segment (4) has at least one barrier (48) with at least one passage (282).

8. A method for exchanging a segment (4) of an outflow trough (5) which is composed of multiple segments (4), wherein at least one segment (4) has an outflow (42) and at least one segment (4) has a partition (46), having the steps of closing the partition (46), evacuating a segment (4) to be exchanged, removing the segment (4) to be exchanged, and adding a new segment (4).

9. The method as claimed in claim 8, wherein the removal of the segment (4) to be exchanged and the addition of the new segment (4) are performed at one end of the outflow trough (5).

10. The method as claimed in claim 8, wherein the removal of the segment (4) to be exchanged is performed at one end of the outflow trough (5), and the addition of the new segment (4) is performed at another end of the outflow trough (5).
